(19) United States
(12) Patent Application Publication
(10) Pub. No.: US 2010/0308036 A1
(43) Pub. Date: Dec. 9, 2010

(54) MICROWAVE IRRADIATION APPARATUS

(75) Inventors: Aki TOMITA, Osaka (JP); Hisato SAIDA, Yaizu-shi (JP)

Correspondence Address: FOLEY AND LARDNER LLP;SUITE 500, 3000 K STREET NW, WASHINGTON, DC, 20007, US

(73) Assignee: SAIDA FDS INC.

(21) Appl. No.: 12/813,949

(22) Filed: Jun. 11, 2010

Related U.S. Application Data
(63) Continuation of application No. PCT/JP2008/072534, filed on Dec. 11, 2008.

(30) Foreign Application Priority Data
Dec. 12, 2007 (JP) 2007-320800

(51) Int. Cl. H05B 6/68

(52) U.S. Cl. 219/756

(57) ABSTRACT

A microwave irradiation apparatus proposed for uniformly treating a large number of samples, includes: an irradiation chamber formed in a rectangular resonant cavity of TM (Transverse Magnetic) 110 mode, of which length of X-axis side is “a” (a>0), length of Y-axis side is “b” (b>0) and length of Z-axis side is “c” (c>0); slits respectively formed on Y-Z plane walls of the irradiation chamber; a transfer sheet entering into the irradiation chamber through the slits and moving along a X-Z plane in the irradiation chamber; and a sample holder disposed on the transfer sheet.

This application is a continuation of PCT/JP/2008/072534, filed on Dec. 11, 2008.

### BACKGROUND OF THE INVENTION

1. Field of the Invention

The present invention relates to a microwave irradiation apparatus for irradiating an object placed in an irradiation chamber with microwave.

2. Description of Related Art

In recent years, in a bio-related field, the usage of microwave for sample treating has been proposed. Namely, a microwave irradiation apparatus has been proposed, in which the microwave irradiation apparatus uses a conventional microwave cooking oven treating a sample held by a sample holder placed therein. In this case, it is difficult to uniformly irradiate a plurality of samples held by the sample holder with the microwave.

In the case of the conventional microwave oven, it is inevitable that a strong portion of microwave and a weak portion of microwave appear in the irradiation chamber due to the generation of standing waves. Thus, it is difficult to uniformly heat the plural samples placed on the sample holder to the temperatures around 40° C. For solving this problem, an approach as disclosed in Japanese Laid-open (Kokai) Patent Application Publication No. 1995-198572 (Patent Literature 1) and Japanese Laid-open (Kokai) Patent Application Publication No. 1997-017566 (Patent Literature 2) has been proposed. Therein, the sample holder is further devised to achieve the uniform irradiation for all of the samples, by linking an interval between wells of the sample holder with the wavelength of microwave, and furthermore, by disposing an object serving as a dummy load under the sample holder.

In the technology disclosed in each of the Patent Literatures, a batch process is performed by manually carrying the sample holder holding the samples into and then out from the irradiation chamber in each case. Therefore, an automatic consecutive process for treating the multiple samples held by the sample holders has not been considered in the prior art. In treating samples related to biotechnology or medical care, it is necessary that the samples, each of which is in small amounts, are uniformly heated to the relatively low temperatures about 40° C. However, a microwave irradiation apparatus capable of consecutively treating a large number of samples while emitting microwave of low power suitable for this low temperature uniform heating has not yet been proposed.

### SUMMARY OF THE INVENTION

In view of the problems encountered by the conventional technology as described above, the present invention describes a microwave irradiation apparatus capable of uniformly treating a large number of samples at the same time, and also capable of performing the automatic consecutive process as needed.

A microwave irradiation apparatus according to one aspect of the present invention including: an irradiation chamber formed in a rectangular resonant cavity of TM (Transverse Magnetic) 110 mode, of which length of X-axis side is “a” (a>0), of which Y-axis side is “b” (b>0) and of which length of Z-axis side is “c” (c>0); a slit formed on a Y-Z plane wall of the irradiation chamber; a transfer sheet entering into the irradiation chamber through the slit and moving along a X-Z plane in the irradiation chamber; and a sample holder disposed on the transfer sheet.

The object and advantages of the invention will be realized and attained by means of the elements and combinations particularly pointed out in the appended claims.

It is to be understood that both the foregoing general description and the following detailed description are exemplary and explanatory and are not restrictive of the invention, as claimed.

### BRIEF DESCRIPTION OF THE DRAWINGS

FIGS. 1A and 1B are explanatory views of an irradiation chamber formed in a rectangular resonant cavity of TM 110 mode;

FIG. 2 is a view showing an embodiment of a microwave irradiation apparatus according to the present invention;

FIG. 3 is a view of an irradiation chamber portion of the microwave irradiation apparatus showing an embodiment of a movement mechanism of a transfer sheet;

FIGS. 4A to 4D are views showing arrangement examples of sample holding wells in a sample holder;

FIGS. 5A to 5D are views showing configuration examples of the sample holder;

FIG. 6 is a view showing an embodiment of the microwave irradiation apparatus including a temperature measuring device;

FIG. 7 is a view showing an example in which a thermal indicator is used in the microwave irradiation apparatus of FIG. 6; and

FIG. 8 is a view showing an embodiment of the microwave irradiation apparatus including temperature measuring devices placed on the front and rear of the irradiation chamber.

### DESCRIPTION OF THE PREFERRED EMBODIMENTS

In the rectangular resonant cavity of TM 110 mode, the microwave makes an electric field distribution in the shape of sine half-wave along an X-axis and a Y-axis, and furthermore, makes a fixed electric field distribution along a Z-axis. Namely, in the irradiation chamber formed in the rectangular resonant cavity, the length “a” of X-axis side and the length “b” of Y-axis side are respectively coincident with the sine half-wave, and the fixed electric field distribution is generated along a line segment in a Z-axis direction corresponding to an arbitrary coordinate (x, y). Therefore, when samples are aligned in the Z-axis direction along the X-Z plane having a predetermined coordinate “y” in the irradiation chamber, and then the samples aligned in the Z-axis direction are transferred in an X-axis direction, the samples aligned in the Z-axis direction are efficiently and uniformly irradiated with the microwave, so that the plurality of samples can be uniformly and consecutively treated. Namely, when the transfer sheet is made to enter into the irradiation chamber through the slit formed on the Y-Z plane wall of the irradiation chamber, to be moved along the X-Z plane in the irradiation chamber, the microwave irradiation apparatus including this transfer sheet having the sample holder can uniformly and consecutively treat a large number of samples.

First of all, the principle of the present invention is explained.

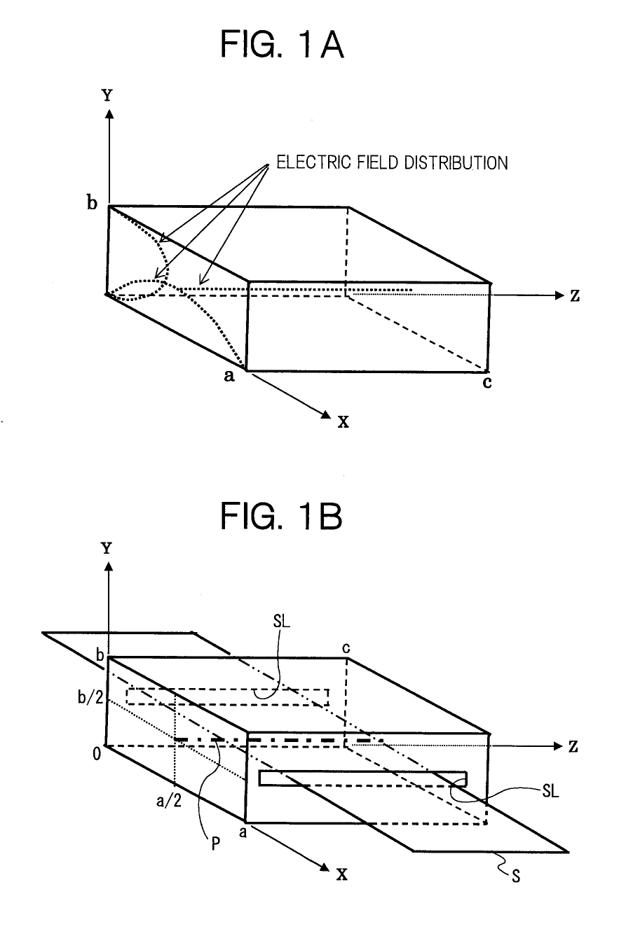

As shown in FIG. 1A, in a rectangular resonant cavity of TM110 mode, each electric field distribution along an X-axis and a Y-axis is in the shape of sine half-wave, and an electric field distribution along a Z-axis is fixed. Therefore, in the case in which this rectangular resonant cavity of TM110 mode is used as an irradiation chamber, when a plurality of objects to be irradiated is aligned in a Z-axis direction upon a sheet body S which passes through the irradiation chamber in an X-axis direction along an X-Z plane having an arbitrary coordinate “y”, microwave is uniformly emitted to the objects so that the plural objects can be efficiently and uniformly treated.

In particular, in the case in which the rectangular resonant cavity of TM 110 mode, of which length of X-axis side is “a” (a>0: the unit thereof is millimeter, as an example), of which length of Y-axis side is “b” (b>0: the unit thereof is millimeter, as an example) and of which length of Z-axis side is “c” (c>0: the unit thereof is millimeter, as an example), is used as the irradiation chamber, as shown in FIG. 1 B, when the sheet body S passes through the irradiation chamber in the X-axis direction along the X-Z plane having a coordinate “y=b/2” at which microwave intensity along the Y-axis reaches a peak, the sheet body S moves via a line segment P in the Z-axis direction having a coordinate (x, y)=(a/2, b/2) on which the microwave intensity becomes maximum. Therefore, when a plurality of objects to be irradiated is aligned in the Z-axis direction upon the sheet body S, the objects are uniformly irradiated with the microwave so that the plural objects can be efficiently and uniformly treated. In this case, the sheet body S may be made to enter into the irradiation chamber through two slits SL, SL formed on Y-Z plane walls of the irradiation chamber. In particular, one of the slits SL, SL through which the sheet body S passes in the X-axis direction along the X-Z plane having the coordinate “y=b/2” is formed along a center line having a coordinate (x, y)=(0, b/2) and extending in the Z-axis direction on the Y-Z plane wall, and the other of the slits SL, SL is formed along a center line having a coordinate (x, y)=(a, b/2) and extending in the Z-axis direction on the Y-Z plane wall.

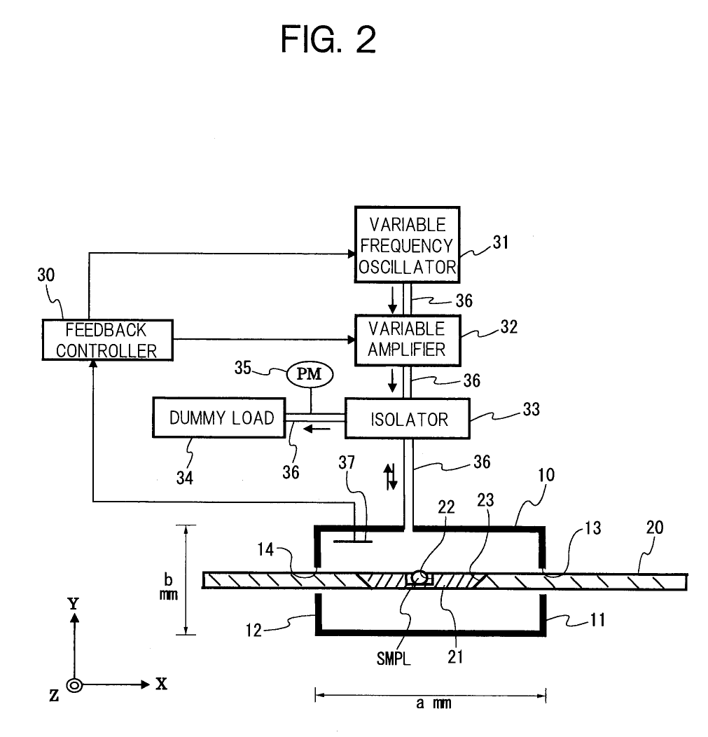

FIG. 2 shows a schematic view of an embodiment of a microwave irradiation apparatus based on the above-mentioned principle.

An irradiation chamber 10 according to this embodiment is formed as a rectangular resonant cavity of TM110 mode as shown in FIG. 1, in which the length of X-axis side is “a (millimeter)”, the length of Y-axis side is “b (millimeter)” and the length of Z-axis side is “c (millimeter)”. Furthermore, slits 13 and 14 are formed on Y-Z plane walls 11 and 12 of the irradiation chamber 10, respectively. The Y-Z plane wall 11 is formed in a Y-Z plane having a coordinate “x=a”, and the slit 13 is formed on the Y-Z plane wall 11 so that a center line of the slit 13 is coincident with a line segment in a Z-axis direction having a coordinate (x, y)=(a, b/2) (but, it is unnecessary that the center line of the slit 13 is precisely coincident with the line segment in the Z-axis direction). Moreover, the Y-Z plane wall 12 is formed in a Y-Z plane of a coordinate “x=0”, and the slit 14 is formed on the Y-Z plane wall 12 so that a center line of the slit 14 is coincident with a line segment in the Z-axis direction having a coordinate (x, y)=(0, b/2) (but, it is unnecessary that the center line of the slit 14 is precisely coincident with the line segment in the Z-axis direction).

A transfer sheet 20 passes through the irradiation chamber 10 via the slits 13 and 14, and is movable along the X-Z plane having the coordinate “y=b/2” in the irradiation chamber 10 (however, it is unnecessary that the transfer sheet 20 precisely trace the X-Z plane). A sample holder 21 is attached to the transfer sheet 20, and a sample holding well 22 for holding a sample SMPL is formed on the sample holder 21 to be a concave portion. The sample holder 21 has a trapezoidal cross-sectional shape in which a lower base is shorter than an upper base, and is attached to an opening portion 23 of the transfer sheet 20, which is formed in a trapezoidal cross-sectional shape corresponding to that of the sample holder 21. Thus, when the sample holder 21 is attached to the transfer sheet 20, the sample holder 21 fills in the opening portion 23, and upper and lower surfaces of the sample holder 21 and that of the transfer sheet 20 are flat each other, respectively. Therefore, in the transfer sheet 20, an outer shape of a portion having the sample holder 21 is approximately same as an outer shape of the other portion. Namely, the whole of upper and lower surfaces of the transfer sheet 20, including the portion having the sample holder 21, has an approximately flat shape except the sample holding well 22.

Furthermore, the transfer sheet 20 and the sample holder 21 are formed, respectively, by using a material having a low microwave absorption property, in order to prevent from disturbing the microwave in the irradiation chamber 10, or improve energy efficiency. In particular, for example, the material has a dielectric constant εr of 10 or less, and also, a dielectric loss angle tan δ of 0.0005 or less. As examples of such material, polystyrene (εr≈2.8, tan δ≈0.0003), silica glass (εr≈3.8, tan δ≈0.00015) or polytetrafluoro-ethylene (εr≈2.2, tan δ≈0.0002) may be adopted. In addition, polypropylene, polyethylene or the like may be adopted. The transfer sheet 20 and the sample holder 21 may be formed by using the same material to make both dielectric constants thereof to be approximately equal to each other, in order to prevent from disturbing the microwave.

Otherwise, the dielectric constant of the transfer sheet 20 and that of the sample holder 21 may be determined to be closer to (if possible, to be same as) a dielectric constant of the sample SMPL as closer as possible. As a target value, a difference between the dielectric constant of the transfer sheet 20 and that of the sample holder 21, and the dielectric constant of the sample SMPL, is made to be εr≈≦10. In this case, although the energy efficiency is degraded in comparison with the case described above, an object to prevent deviation between resonant conditions is satisfied.

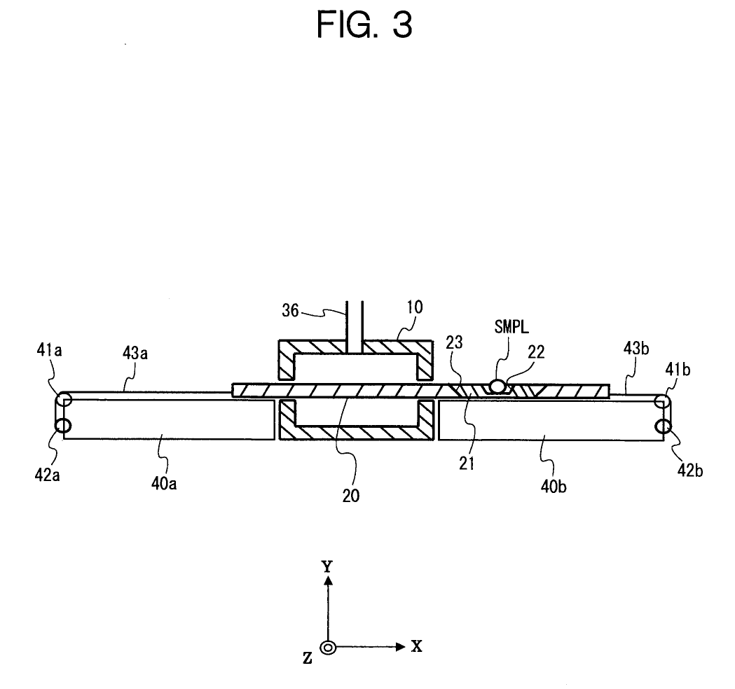

The length (in the X-axis direction) of the transfer sheet 20 is sufficiently longer than the length “a” of X-axis side of the irradiation chamber 10 (for example, twice or longer than the length “a”). In particular, as shown in FIG. 3, a portion of the transfer sheet 20, which precedes the sample holder 21, may pass through the irradiation chamber 10, before the sample holder 21 enters into the irradiation chamber 20. In this case, in the state where the preceding portion of the transfer sheet 20 entered into the irradiation chamber 10, the microwave irradiation is started and then a power condition of the microwave can be regulated. Thus, when the transfer sheet 10 is moved subsequently to thereby enter the sample holder 21 into the irradiation chamber 10, microwave turbulence can be suppressed.

The microwave turbulence suppression is explained as follows. Firstly, differently from the example shown in FIG. 3, it is assumed that the microwave irradiation is started and then the power condition of the microwave is regulated in the empty irradiation chamber 10, and thereafter, the transfer sheet 20 starts to enter. In this case, since properties in the irradiation chamber 10 are drastically changed due to the entrance of the transfer sheet 20, the change in the properties affects the resonant condition. However, as shown in FIG. 3, when the microwave is regulated in the state where the transfer sheet 20 entered into the irradiation chamber 10 in advance, even though the transfer sheet 20 is moved subsequently, the change in the properties is small, and therefore, the microwave is less affected by the change in the properties. Furthermore, since the dielectric constant of the transfer sheet 20 is coincident with that of the sample holder 21, the effect on the microwave is also small when the sample holder 21 enters into the irradiation chamber 10 following the transfer sheet 20.

A control section which emits the microwave into the irradiation chamber 10 includes a feedback controller 30, a variable frequency oscillator 31, a variable amplifier 32, an isolator 33, a dummy load 34, a power monitor 35, and a coaxial cable 36 for microwave propagation.

The variable frequency oscillator 31 generates microwave having predetermined frequency and sends the microwave to the variable amplifier 32 through the coaxial cable 36. The variable amplifier 32 capable of pre-setting amplifying level thereof, can perform five-level amplification of 2W (watt) to 5W in the case of feed-through mode process as described below, and also, can perform amplification in response to a control signal from the feedback controller 30 in the case of set position mode process. The amplified microwave is transmitted through the coaxial cable 36 to be led into the irradiation chamber 10 via the isolator 33. The isolator 33 leads a reflected wave from the irradiation chamber 10 to the dummy load 34, and thereby, the reflected wave does not return to the variable amplifier 32. The reflected wave led to the dummy load 34 is converted into the heat. Since the reflected wave sent from the isolator 33 to the dummy load 34 can be monitored by the power monitor 35, a consumed power in the irradiation chamber 10 can be actually measured based on [consumed power in the irradiation chamber 10]=[displayed power at an output end of the variable amplifier 32]−[displayed power of the power monitor 35]. The feedback controller 30 outputs the control signal based on a detection signal detected from an antenna 37 disposed in the irradiation chamber 10, to thereby control the variable frequency oscillator 31 and the variable amplifier 32. The antenna 37 detects a magnetic field condition in the irradiation chamber 10, and therefore, the feedback controller 30 controls the variable frequency oscillator 31 and the variable amplifier 32 based on the detection signal detected from the antenna 37 so that the magnetic field condition in the irradiation chamber 10 is kept optimum.

By operating a control panel (not shown in FIG. 3) included in the control section as described above, a power of the apparatus can be turned on or off, an output power of the variable amplifier can be determined, a moving speed of the transfer sheet can be determined, a forward or backward movement of the transfer sheet can be switched, a home position of the transfer sheet can be set, a treating time and temperature related to sample can be determined, settings of a data logger can be changed, etc.

FIG. 3 shows one example of a movement mechanism for the transfer sheet 20. This movement mechanism includes supporting beds 40a and 40b disposed on both sides in the X-axis direction of the irradiation chamber 10. The supporting beds 40a and 40b support projecting portions of the transfer sheet 20 which project from the irradiation chamber 10 through the slits 13 and 14. The supporting beds 40a and 40b include pulleys 41a and 41b disposed on each outside corner portion of the supporting beds 40a and 40b, and winders 42a and 42b disposed on each outer end portion of the supporting beds 40a and 40b. Traction cords 43a and 43b are extracted from the winders 42a and 42b respectively, to be fastened to end portions of the transfer sheet 20 via the pulleys 41a and 41b.

According to this movement mechanism, when the one winder 42a (left side in FIG. 3) performs a winding operation while the other winder 42b (right side in FIG. 3) being in an idle state, the transfer sheet 20 is moved forwards in the X-axis direction so that the sample holder 21 enters into the irradiation chamber 10. On the other hand, when the other winder 42b (right side in FIG. 3) performs a winding operation while the one winder 42a being in an idle state, the transfer sheet 20 is moved backwards, so that the sample holder 21 is ejected from the irradiation chamber 10.

Regarding the movement mechanism for the transfer sheet 20, other than the above-mentioned movement mechanism, for example, a push-pull mechanism in which an air cylinder, etc. makes to move the transfer sheet 20 may be adopted, or a feed screw mechanism in which a screw makes to move the transfer sheet 20 may be adopted. Furthermore, an endless track mechanism which has an transfer sheet to be an endless conveyer by connecting both ends of the flexible transfer sheet 20 to each other may be adopted.

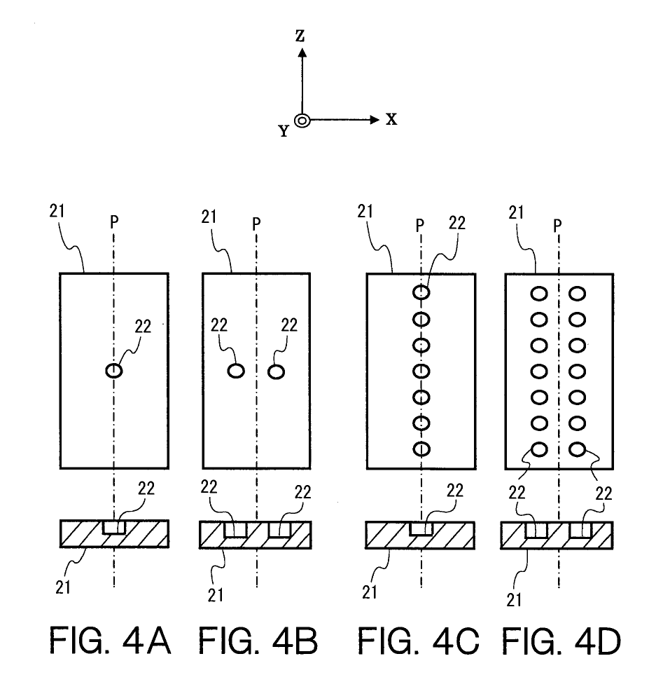

FIG. 4 shows various shapes of the sample holder 21 attached to the transfer sheet 20, that is, various layouts of sample holding well 22 formed on the sample holder 21.

FIG. 4A shows an example in which one sample holding well 22 is formed on a center portion of the sample holder 21, and FIG. 4B shows an example in which two sample holding wells 22 are formed in line in the X-axis direction. In the example shown in FIG. 4B, when the sample holder 21 enters into the irradiation chamber 10, the two sample holding wells 22 may be symmetrically positioned with respect to the above described line segment P in the Z-axis direction as a symmetry axis. FIG. 4C shows an example in which a plurality of sample holding wells 22 is formed in line in the Z-axis direction. In this example, when the sample holder 21 enters into the irradiation chamber 10, the respective sample holding wells 22 may be positioned along the above described line segment P in the Z-axis direction. FIG. 4D shows an example in which a plurality of sample holding wells 22 is formed in two lines in parallel with each other in the Z-axis direction. In this example, when the sample holder 21 enters into the irradiation chamber 10, the two lines of the sample holding wells 22 may be symmetrically positioned with respect to the above described line segment P in the Z-axis direction as a symmetry axis.

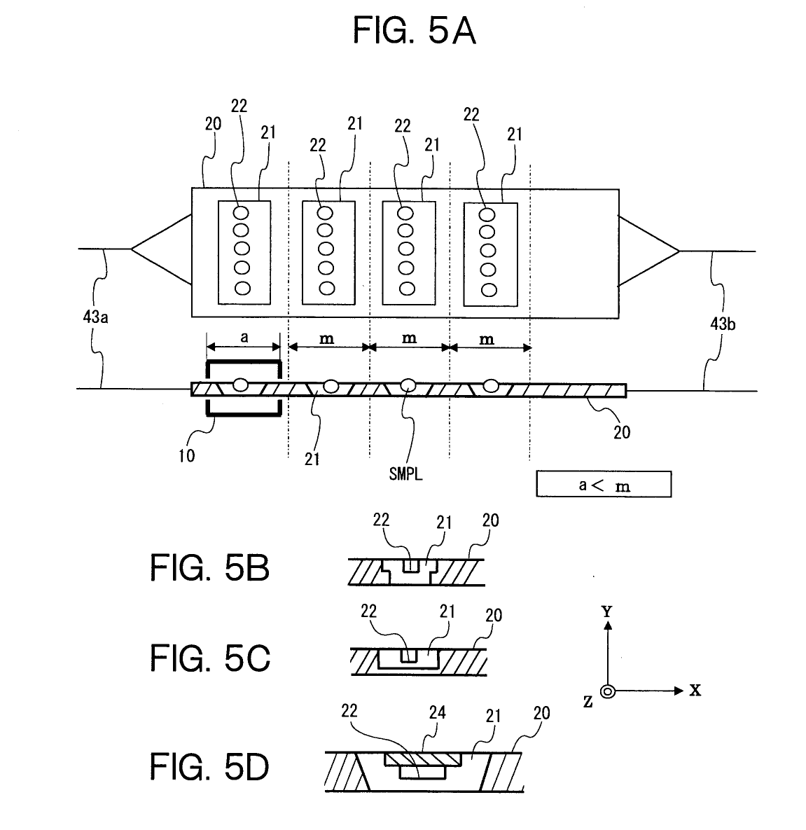

FIG. 5 shows an example in which a plurality of sample holders 21 is attached to the transfer sheet 20. As shown in FIG. 5A, the plurality of sample holders 21 is aligned in the X-axis direction on the transfer sheet 20, and the in-line sample holding wells 22 shown in FIG. 4C are formed on each sample holder 21. A disposing pitch “m” between the sample holders 21 in the X-axis direction is longer than the length “a” of X-axis side of the irradiation chamber 10. Thus, when the samples held by one of the sample holders 21 are located in the irradiation chamber 10, the samples held by the remaining sample holders 21 are located outside the irradiation chamber 20.

FIGS. 5B, 5C and 5D show examples of shape for attaching the sample holder 21 to the transfer sheet 10, respectively. Other than the above-mentioned trapezoidal shape, the examples shown in FIGS. 5B, 5C and 5D may be adopted. In the example of FIG. 5B, the sample holder 21 has a downward convex cross-sectional shape for forming engageable steps of the sample holder and the transfer sheet. In the example of FIG. 5C, the opening portion having a bottom wall is formed on the transfer sheet 20, and the sample holder 21 has a cross-sectional shape corresponding to the opening portion to be inserted thereinto. In the example of FIG. 5D, the sample holding well 22 is covered with a silica glass lid 24.

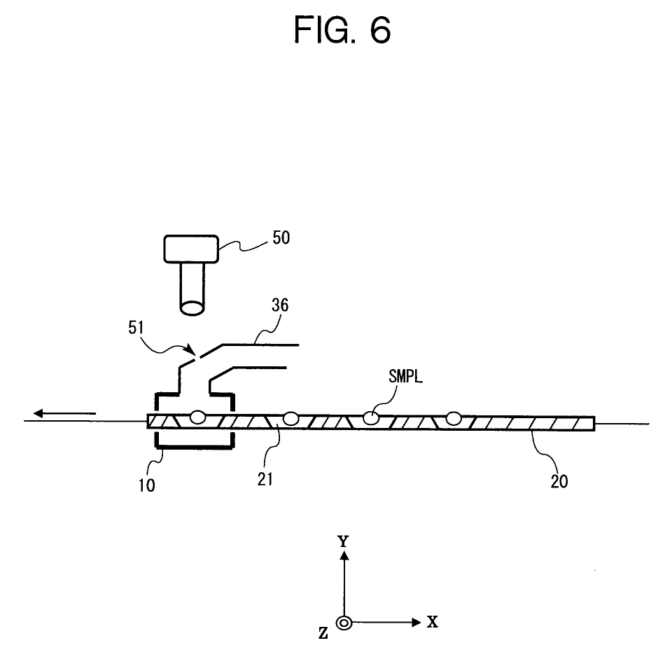

The above-mentioned microwave irradiation apparatus may include a temperature measuring device for measuring the temperature of the sample SMPL located in the irradiation chamber 10. The control section controls the microwave power based on a measuring signal output from the temperature measuring device. FIG. 6 shows an example of the temperature measuring device.

In this example shown in FIG. 6, a radiation thermometer 50 is used as the temperature measuring device. The radiation thermometer 50 measures the temperature of the sample SMPL located on the position of the coordinate (x, y)=(a/2, b/2) in the irradiation chamber 10, that is, on the above described line segment P in the Z-axis direction, through a measuring hole 51 formed on the coaxial cable 36 (waveguide). The measuring position is not limited to this position, but the measurement at the maximum area of the microwave intensity is suitable for a detection of excessive rise of the temperature or the like. By inputting the temperature measuring signal to the feedback controller 30, the microwave power and the transfer sheet moving speed can be controlled.

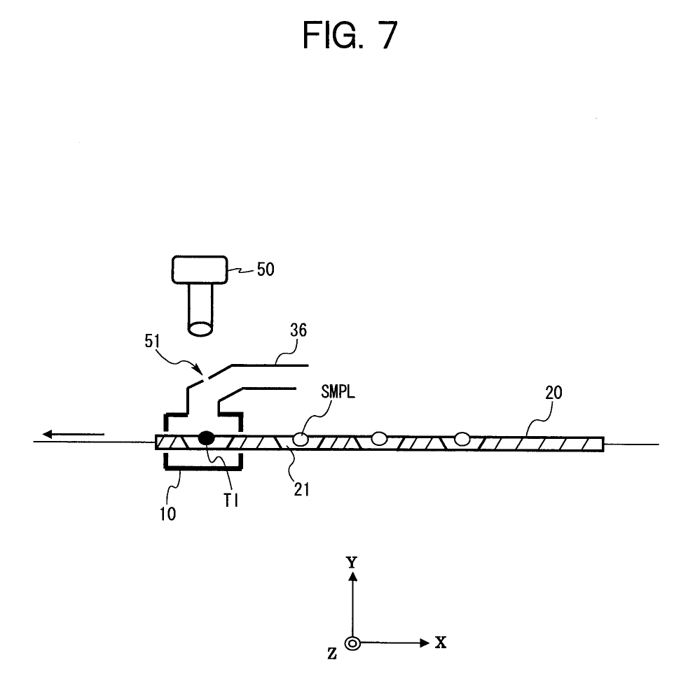

In the microwave irradiation apparatus having the temperature measuring device, before starting to treat the sample SMPL, it is possible to verify whether or not a desired state in the irradiation chamber 10 is achieved, and/or whether or not the microwave irradiation apparatus normally operates. As shown in FIG. 7, first of all, a thermal indicator TI held by the first sample holder 21 enters into the irradiation chamber 10, and then the thermal indicator TI is irradiated with the definite quantity of microwave. A temperature rise of the thermal indicator TI by this irradiation is measured by the radiation thermometer 50, and the above-mentioned state and/or operation are verified based on the measuring result. As the thermal indicator TI, an indicator having a high dielectric constant and a high microwave absorption characteristic may be adopted. This indicator has a high temperature rise characteristic and thereby the temperature measurement with high precision can be achieved. For example, a thermal transfer ink ribbon used in a thermal transfer printer is adopted as the indicator. The color of this ribbon is black, and thus, this ribbon is suitable for the radiation thermometer 50.

Incidentally, in the case in which the above control using the indicator, a calibration graph indicating a relation between a microwave irradiation amount (microwave intensity x microwave irradiation time) and the temperature of the thermal indicator TI is prepared in advance. Furthermore, a correlation between the temperature of the thermal indicator TI and that of the sample SMPL is also prepared in advance.

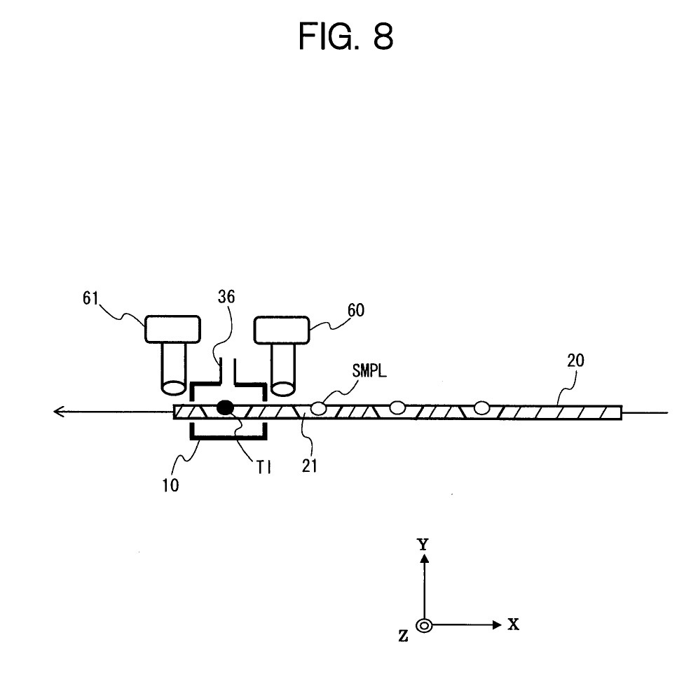

Other example of the temperature measuring device is shown in FIG. 8. In this example, radiation thermometers 60 and 61 are disposed on the front and rear of the irradiation chamber 10 as the temperature measuring devices, to thereby measure the temperature of the sample SMPL. The first radiation thermometer 60 measures the temperature of the sample arriving the irradiation chamber 10, and the second radiation thermometer 61 measures the temperature of the sample leaving the irradiation chamber 10. Measuring signals output from these radiation thermometers 60 and 61 are input to the feedback controller 30, and then the microwave power and the moving speed are controlled by the control section based on these measuring signals.

In particular, the first radiation thermometer 60 measures the temperature of the sample before treatment and the second radiation thermometer 61 measures the temperature of the sample after treatment. Based on a difference between the measured temperatures, it is determined whether or not the normal operation of the microwave irradiation apparatus is performed. Also in this case, it is possible to perform an irradiation trial on the thermal indicator TI in advance. Namely, the thermal indicator TI held by the first sample holder 21 firstly enters into the irradiation chamber 10, and the first radiation thermometer 60 measures the temperature of the thermal indicator TI before treatment and the second radiation thermometer 61 measures the temperature of the thermal indicator TI after treatment. Based on a difference between the measured temperatures, it is determined whether or not a normal microwave emitting is performed. As a result, when the normal operation of the microwave irradiation apparatus is determined, the samples SMPL held by the subsequent sample holders 21 are treated. These radiation thermometers 60 and 61 may be used together with the above described radiation thermometer 50.

The thermal indicator TI is held by the sample holder 21 in the above-mentioned examples. However, the thermal indicator TI may be directly attached to the transfer sheet 20 to be checked at each time.

The following is one example of specifications of the above described microwave irradiation apparatus. The variable frequency oscillator 31 can vary frequency from 2 GHz to 6 GHz or from 2.4 GHz to 2.5 GHz (lower cost version). Regarding the irradiation chamber 10 formed in the rectangular resonant cavity of TM110 mode, the length “a” of X-axis side is 130 mm in outer length/109.2 mm in inner length, the length “b” of Y-axis side is 84 mm in outer length/73.8 mm in inner length, the length “c” of Z-axis side is 240 mm in outer length/200 mm in inner length, a width of each of the slits 13 and 14 is 200 mm, a height of each of the slits 13 and 14 is 8 mm, and a diameter of the temperature measuring hole 51 is 5 mm. The transfer sheet 20 is made from polystyrene material, the length thereof in the X-axis direction is 800 mm, the thickness thereof in the Y-axis direction is 2 mm, the width thereof in the Z-axis direction is 180 mm, and the disposing pitch “m” of the sample holder 21 is 160 mm. The opening portion 23 has the trapezoidal cross-sectional shape corresponding to that of the sample holder 21. The sample holder 21 is made from polystyrene material, the length thereof in the X-axis direction is 40 mm, the thickness thereof in the Y-axis direction is 2 mm, and the width thereof in the Z-axis direction is 180 mm. The sample holding well 22 of the sample holder 21 is formed in a hole shape, the opening diameter thereof is 8 mm, and the depth thereof is 0.5 mm

The microwave irradiation apparatus according to the present embodiment can perform two types of treating modes, that is, the set position mode process and the feed-through mode process.

In the set position mode process, the transfer sheet 20 moves and the sample holder 21 enters into the irradiation chamber 10, and then, the transfer sheet 20 stops when the sample SMPL held by the sample holding well 22 of the sample holder 21 reaches the position equivalent to the line segment P. At this position, the sample SMPL is irradiated with the predetermined amount of microwave (microwave intensity×microwave irradiation time). After the irradiation is finished, the transfer sheet 20 moves and the sample SMPL is ejected from the irradiation chamber 10. Namely, in the set position mode process, each time one sample holder 21 enters into the irradiation chamber 10, once the transfer sheet 20 stops and the sample SMPL is irradiated.

In the feed-through mode process, the transfer sheet 20 moves at a constant speed while keeping the microwave to emit under a fixed condition into the irradiation chamber 10. Therefore, the sample SMPL held by the sample holding well 22 of the sample holder 21 is treated without stopping in the irradiation chamber 10. Namely, the feed-through mode process is the same as a so-called conveyor system mode performing the irradiation with the transfer using a belt conveyor.

Regarding these modes, control flows thereof are explained as follows, in the case in which the thermal indicator TI is used as an example. These flows are executed by the feedback controller 30.

In the set position mode process, for example, the microwave irradiation apparatus provided with the radiation thermometer 50 shown in FIG. 7 is used. First, the sample holder 21 holding the thermal indicator TI is set at a leading position of the transfer sheet 20, and also, the sample holders 21 holding the samples SMPL are set at subsequent positions of the transfer sheet 20. Then, according to the controlling by the feedback controller 30, the transfer sheet 20 moves and the thermal indicator TI enters into the irradiation chamber 10. The thermal indicator TI entering in the irradiation chamber 10 stops at the position of the line segment P. At this position, the microwave set under a predetermined irradiation condition is emitted to start the treating. At the same time of the irradiation starting, the temperature of the thermal indicator TI is measured by the radiation thermometer 50, and on the basis of the measuring signal, it is monitored whether or not the temperature of the thermal indicator TI reaches the predetermined target temperature. According to this precedent irradiation verification step using the thermal indicator TI, it is determined whether or not the microwave irradiation apparatus normally operates and whether or not the setting condition of the microwave is adaptable. As a result of determining, when it is necessary to revise the condition setting, etc., the condition is altered, and then, the treatment of the thermal indicator TI is started again.

When the temperature of the thermal indicator TI reaches the target temperature, the microwave irradiation is stopped, and subsequently, the transfer sheet 20 moves and the sample holder 21 holding the sample SMPL placed on the position next to the thermal indicator TI enters into the irradiation chamber 10. This sample SMPL also stops at the position of the line segment P, and is irradiated with the microwave under the same condition. Then, the temperature of the sample SMPL is measured by the radiation thermometer 50, and when it is determined that the temperature of the sample SMPL reaches the target temperature based on the measuring signal output from the radiation thermometer 50, the microwave irradiation is stopped. After the microwave irradiation is stopped, the transfer sheet 20 moves and the treated sample SMPL is ejected from the irradiation chamber 10, and continuously, the sample SMPL held by the further subsequent sample holder 21 enters into the irradiation chamber 10. Thereafter, the same process of “transfer→stop→microwave irradiation→microwave irradiation stop→eject” is executed on each of the samples SMPL held by all the subsequent sample holders 21.

In the feed-through mode process, for example, the microwave irradiation apparatus provided with the radiation thermometers 60 and 61 shown in FIG. 8 is used. First, the sample holder 21 holding the thermal indicator TI is set at a leading position of the transfer sheet 20, and also, the sample holders 21 holding the samples SMPL are set at subsequent positions of the transfer sheet 20. Then, according to the controlling by the feedback controller 30, the microwave irradiation set under a predetermined irradiation condition is started, and furthermore, the movement of the transfer sheet 20 set at a predetermined moving speed is started.

When the thermal indicator TI travels for the irradiation chamber 10 according to the movement of the transfer sheet 20, firstly, the temperature of the thermal indicator TI arriving the irradiation chamber 10 is measured by the first radiation thermometer 60. Subsequently, the sample holder 21 holding the thermal indicator TI enters into the irradiation chamber 10 and the thermal indicator TI is treated by the microwave irradiation. The thermal indicator TI passes through the irradiation chamber 10 with treating, and the second radiation thermometer 61 measures the temperature of the thermal indicator TI leaving the irradiation chamber 10. Based on the measuring signals from the first and second radiation thermometers 60 and 61, it is determined whether or not the temperature of the thermal indicator TI reaches the predetermined target temperature. According to this precedent irradiation verification step using the thermal indicator TI, it is determined whether or not the microwave irradiation apparatus normally operates and whether or not the setting conditions of the microwave and a transfer speed (moving speed of the transfer sheet) are adaptable. As a result of determining, when it is necessary to revise the condition setting, etc., the condition is altered, and then, the treatment of the thermal indicator TI is started again.

When the temperature of the thermal indicator TI reaches the target temperature, the movement of the transfer sheet 20 is kept and the subsequent sample holder 21 holding the sample SMPL placed on the position next to the thermal indicator TI enters into the irradiation chamber 10. This sample SMPL similarly passes through the irradiation chamber 10 with the microwave irradiation treating, and then, the temperature of the sample SMPL is measured by the first and second radiation thermometers 60 and 61. Based on the measuring signals output from the first and second radiation thermometers 60 and 61, it is determined whether or not the temperature of the sample SMPL reaches the target temperature. Thereafter, the same process of “transfer and microwave irradiation” is executed on each of the samples SMPL held by all the subsequent sample holders 21 with monitoring the temperature.

It should be appreciated that the entire contents of Japanese Patent Application No. 2007-320800, filed on Dec. 12, 2007, on which the convention priority is claimed is incorporated herein by reference.

It should also be understood that many modifications and variations of the described embodiments of the invention will occur to a person having an ordinary skill in the art without departing from the spirit and scope of the present invention as claimed in the appended claims.

What is claimed is:

1. A microwave irradiation apparatus comprising:
an irradiation chamber formed in a rectangular resonant cavity of TM (Transverse Magnetic) 110 mode, of which length of X-axis side is “a” (a>0), length of Y-axis side is “b” (b>0) and length of Z-axis side is “c” (c>0);
a slit formed on a Y-Z plane wall of the irradiation chamber;
a transfer sheet entering into the irradiation chamber through the slit and moving along a X-Z plane in the irradiation chamber; and
a sample holder disposed on the transfer sheet.

2. The microwave irradiation apparatus according to claim 1, wherein
the sample holder includes plural sample holding wells formed in line in a Z-axis direction.

3. The microwave irradiation apparatus according to claim 1, wherein
the sample holder includes two sample holding wells formed in line in a X-axis direction.

4. The microwave irradiation apparatus according to claim 1, wherein
the sample holder includes plural sample holding wells formed in two lines in parallel with each other in a Z-axis direction.

5. The microwave irradiation apparatus according to claim 1, wherein
at least two sample holders are aligned in an X-axis direction on the transfer sheet, and
a disposing pitch between the sample holders in the X-axis direction is determined, so that a sample held by one of the sample holders is located in the irradiation chamber and the other sample held by the remaining sample holder is located outside the irradiation chamber.

6. The microwave irradiation apparatus according to claim 1, wherein
a dielectric constant of the transfer sheet and a dielectric constant of the sample holder are approximately equal to each other.

7. The microwave irradiation apparatus according to claim 6, wherein
an outer shape of a portion of the transfer sheet to which the sample holder is attached, is approximately same as an outer shape of the other portion of the transfer sheet.

8. The microwave irradiation apparatus according to claim 1, wherein
a length of the transfer sheet in an X-axis direction is longer than the length “a”, and thereby, a portion of the transfer sheet which precedes the sample holder passes through the irradiation chamber before the sample holder enters into the irradiation chamber.

9. The microwave irradiation apparatus according to claim 1, further comprising:
a first slit along a center line having a coordinate (x, y)=(0, b/2) and extending in a Z-axis direction; and
a second slit along a center line having a coordinate (x, y)=(a, b/2) and extending in the Z-axis direction.

10. The microwave irradiation apparatus according to claim 1, further comprising:
an antenna that detects a magnetic condition inside the irradiation chamber; and
a control section that controls microwave to be provided to the irradiation chamber, based on a detection signal output from the antenna.

11. The microwave irradiation apparatus according to claim 1, further comprising:
a temperature measuring device for measuring a temperature of the sample located in the irradiation chamber; and
a control section that controls microwave to be provided to the irradiation chamber, based on a measuring signal output from the temperature measuring device.

12. The microwave irradiation apparatus according to claim 1, further comprising:
a first measuring device for measuring a temperature of the sample arriving the irradiation chamber;
a second measuring device for measuring a temperature of the sample leaving the irradiation chamber; and
a control section that controls microwave to be provided to the irradiation chamber, based on measuring signals output from the first and second temperature measuring devices.
